(19) United States
(12) Patent Application Publication
(10) Pub. No.: US 2014/0122762 A1
(43) Pub. Date: May 1, 2014

(54) APPLICATION MERGING SYSTEM FOR MULTIPLE PLATFORMS FPGA OF A SAME SERIES

(71) Applicant: Celestica Technology Consultancy (Shanghai) Co., Ltd., Shanghai (CN)

(72) Inventors: Nianbing YU, Shanghai (CN); Kai HUANG, Shanghai (CN)

(21) Appl. No.: 13/907,482

(22) Filed: May 31, 2013

(30) Foreign Application Priority Data
Oct. 25, 2012 (CN) 201210413817.2

(51) Int. Cl. G06F 13/38

(52) U.S. Cl. CPC G06F 13/382
USPC 710/305

(57) ABSTRACT

Provided is a Field Programmable Gate Array (FPGA) application merging system for multiple platforms of a same series, which is used in a testing or manufacturing system comprising an adapter and at least two platforms. The FPGA application merging system comprises: at least two functional modules corresponding to the at least two platforms respectively; an IO selector connected to the at least two functional modules respectively, configured to select one of the at least two functional modules adaptively; and an IO attribute controller connected to the IO selector, configured to select an attribute in accordance with the selected functional module, wherein each IO has a three-state logic attribute. The FPGA application merging system may significantly reduce the cost of the FPGA version in later development, maintenance, storage, upgrading and so on, mitigate the difficulty of storage, loading and other operations on the board, and significantly increase the operation efficiency.

This application claims priority to Chinese Patent Application No. 201210413817.2 filed on Oct. 25, 2012.

### BACKGROUND

Nowadays the FPGA has become “glue” for modern digital application systems and Digital Signal Processor (DSP) chip application systems due to a great amount of Flip-Flop (FF) disposed in the FPGA and many Input/output (I/O) pins of the FPGA. The programmability of the FPGA improves the interface capability of the DSP. The logical operation in the FPGA chip is saved in a certain storage medium in the form of a configuration file.

Now, the following scene often occurs in product or manufacturing platforms: among different products of a same series, the general architectures of systems are similar but some slight differences still exist therein. Therefore, to reduce the cost in hardware development and manufacturing, a common solution is to design hardware parts compatible with each other into one adapter which is used to accommodate general-purpose devices such as a CPU and an FPGA (i.e., join with different platforms through a slot). However, in this mode, both the hardware and the software of the adapter can use a same FPGA version, but the FPGA needs to use different images to match with corresponding platforms because the pin controlled by the FPGA will be different when being defined on different platforms. As a result, in order to avoid damage caused to the hardware due to different IO electrical signal levels or directions, it shall be particularly noted that different FPGA versions shall not be mixed for use. However, this significantly adds to the difficulty in updating and maintenance of the FPGA version as well as in such operations as storage and loading on the FPGA version board.

It may therefore be desirable to provide an FPGA application merging system for multiple platforms of a same series to solve the problem with the prior art that it is difficult to perform such operations as storage and loading on the FPGA board.

### BRIEF SUMMARY OF THE INVENTION

The present invention belongs to electronic digitization which generally relates to a Field Programmable Gate Array FPGA application merging system, and more particularly, to an FPGA application merging system for multiple platforms of a same series.

To achieve the aforesaid objective and other related objectives, examples of the present invention may provide a FPGA application merging system for multiple platforms of a same series, which is used in a testing system comprising an adapter and at least two platforms. The FPGA application merging system comprises:

at least two functional modules corresponding to the at least two platforms respectively;

an IO selector connected to the at least two functional modules respectively, and configured to select one of the at least two functional modules adaptively; and

an IO attribute controller connected to the IO selector, and configured to select an attribute of an IO of the FPGA application merging system in accordance with the selected one of the at least two functional modules, wherein each IO of the FPGA application merging system has a three-state attribute, i.e., an input state, an output state and a high impedance state.

In another example embodiment, the FPGA application merging system for multiple platforms of a same series further comprises an IO pin connected to the FPGA application merging system, and the IO pin is used to embed the FPGA application merging system into the adapter.

In another example embodiment, the IO attribute controller further comprises a programmable input output block (IOB).

In another example embodiment, each IO of a general-purpose (GPIO) IO ports of the FPGA application merging system to be used by the IO attribute controller has the three-state attribute, i.e., can be configured in real time into the input state, the output state, or the high impedance state.

In another example embodiment, the programmable IOB comprises the three-state logic control port, an output port and an input port.

In another example embodiment, when a signal level at the three-state logic control port is at a low level, the IO of the FPGA application merging system is at the output state; and when the signal level at the three-state logic control port is at a high level, the IO of the FPGA application merging system is at the high impedance state.

In another example embodiment, the FPGA application merging system utilizes a two-stage structure to control the IO of the FPGA application merging system, and the two-stage structure refers to the IO selector and the IO attribute controller.

In another example embodiment, the IO selector at a first stage of the two-stage structure maps an IO configuration of one of the at least two functional modules to the IO of the FPGA application merging system.

In another example embodiment, the IO attribute controller at a second stage of the two-stage structure configures the IO attribute of each IO of the FPGA application merging system in accordance with one of the at least two functional modules.

Some examples of the present invention may provide a Field Programmable Gate Array (FPGA) application merging system for multiple platforms of a same series, which is used in a testing or manufacturing system comprising an adapter and at least two platforms, the FPGA application merging system comprises at least two functional modules corresponding to the at least two platforms respectively; an Input/output (IO) selector connected to the at least two functional modules respectively, and configured to select one of the at least two functional modules adaptively; an IO attribute controller connected to the IO selector, and configured to select an attribute of an IO of the FPGA application merging system in accordance with the selected one of the at least two functional modules; and an IO pin connected to the FPGA application merging system, wherein each IO of the FPGA application merging system has a three-state attribute comprising an input state, an output state and a high impedance state, and the IO pin is used to embed the FPGA application merging system into the adapter.

Still other examples of the present invention may provide a Field Programmable Gate Array (FPGA) application merging system for multiple platforms of a same series, used in a testing or manufacturing system comprising an adapter and at least two platforms, the FPGA application merging system comprises at least two functional modules corresponding to the at least two platforms respectively; an Input/output (IO) selector connected to the at least two functional modules respectively, and configured to select one of the at least two functional modules adaptively; an IO attribute controller connected to the IO selector, and configured to select an attribute of an IO of the FPGA application merging system in accordance with the selected one of the at least two functional modules, the IO attribute controller further comprising a programmable input output block (IOB); and an IO pin connected to the FPGA application merging system, wherein each IO of the FPGA application merging system has a three-state attribute comprising an input state, an output state and a high impedance state, and the IO pin is used to embed the FPGA application merging system into the adapter, wherein the programmable IOB comprises a three-state logic control port, an output port and an input port, and wherein when a signal level at the three-state logic control port is at a low level, the IO of the FPGA application merging system is at the output state; and when the signal level at the three-state logic control port is at a high level, the IO of the FPGA application merging system is at the high impedance state.

As described above, the FPGA application merging system for multiple platforms of a same series in accordance with the present invention can significantly reduce the cost of the FPGA version in later development, maintenance, storage, upgrading and so on, mitigate the difficulty of storage, loading and other operations on the board, and significantly increase the operation efficiency.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings examples which are presently preferred. It should be understood, however, that the invention is not limited to the precise arrangements and instrumentalities shown.

In the drawings:

FIG. 1 is a schematic diagram of an application scene of an FPGA application merging system for multiple platforms of a same series in accordance with an embodiment of the present invention;

FIG. 2 is a schematic diagram of the FPGA application merging system for multiple platforms of a same series in accordance with an embodiment of the present invention;

FIG. 3 is a schematic diagram of a programmable IOB in the FPGA application merging system for multiple platforms of a same series in accordance with an embodiment of the present invention; and

FIG. 4 is a schematic diagram of the FPGA application merging system for multiple platforms of a same series in accordance with an embodiment of the present invention which adapts a single functional module of a current platform.

### DETAILED DESCRIPTION OF INVENTION

Hereinbelow, implementation of the present invention will be described with reference to specific embodiments, and people skilled in the art can readily appreciate other advantages and efficacies of the present invention based on what disclosed in this specification. The present invention may further be implemented or applied in other different embodiments, and details in this specification may also be modified or changed according to different viewpoints and applications without departing from the spirit of the present invention.

Refer to the attached drawings. It shall be appreciated that, the attached drawings in this embodiment are only intended to illustrate the basic concept of the present invention, so the attached drawings only have components related to the present invention shown therein but are not depicted according to the numbers, shapes and dimensions of components in actual implementation. In actual implementation of the present invention, the forms, numbers and proportions of the components may be changed arbitrarily, and arrangement of the components may also be more complex.

Hereinbelow, the present invention will be described in detail with reference to the attached drawings and embodiments thereof.

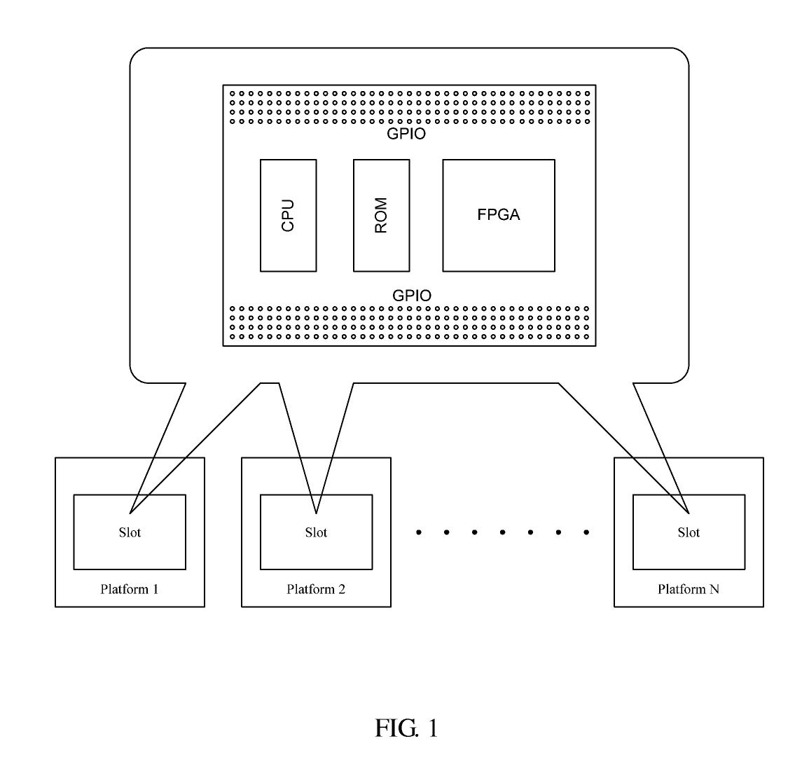

The FPGA application merging system for multiple platforms of a same series is used in a testing or manufacturing system comprising an adapter 1 and at least two platforms 2. The FPGA application merging system 11 for multiple platforms of a same series is embedded in the adapter 1. In an application scene of the FPGA application merging system 11 as shown in FIG. 1, a platform 2₁, a platform 2₂ . . . , a platform 2_{N} represent different platforms, and the N platforms use the same devices in terms of CPUs, FPGAs and so on. The conventional solution for reducing the cost in hardware is to place general-purpose devices into a same adapter and insert the adapter into different platforms 2 via a slot. The IO of the FPGA or the CPU on the adapter 1 may control or access devices on a platform through the slot. However, in the conventional solution, when the adapter 1 is inserted in the different platforms 2, different FPGA images need to be loaded respectively. Through use of the FPGA application merging system for multiple platforms of a same series in accordance with this embodiment, the adapter 1 may be directly inserted into the different platforms 2, and an IO pin is adaptively configured through the FPGA to match with different platform designs.

The FPGA application merging system for multiple platforms of a same series in accordance with the present invention merges the FPGA designs using different platforms into a same image. When there is a need to develop multiple platforms in which a same FPGA is suitable for use, the operation efficiency may be increased significantly.

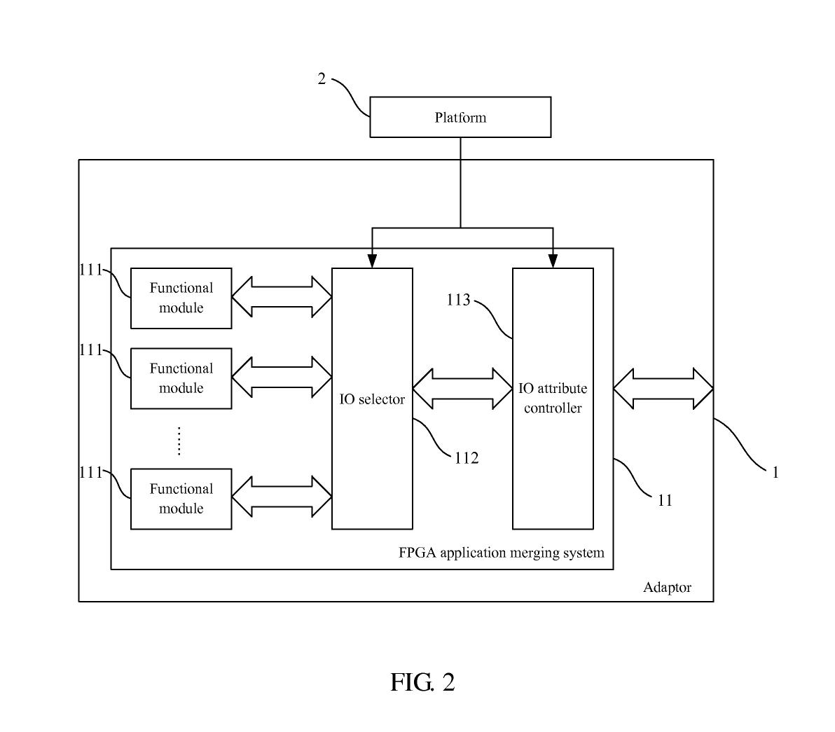

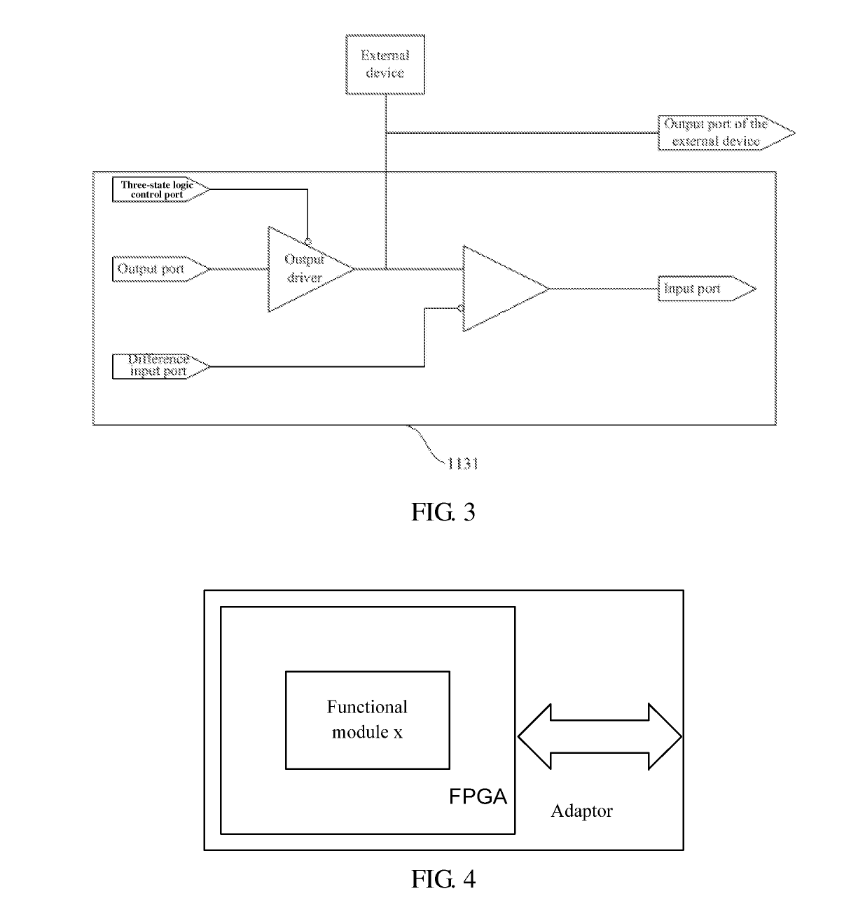

This embodiment provides an FPGA application merging system 11 for multiple platforms of a same series. As shown in FIG. 2, the FPGA application merging system 11 for multiple platforms of a same series comprises: N functional modules 111 corresponding to the platform 2₁, the platform 2₂ . . . , the platform 2_{N} respectively; an IO selector 112 connected to the N functional modules 111 respectively, being configured to select one of the N functional modules 111 adaptively, wherein the function (e.g., the function of operating an external EROM, the function of reading an external sensor, etc.) running on each of the functional modules is set according to a user's needs; an IO attribute controller 113 connected to the IO selector 112, being configured to select an attribute of an IO in accordance with the selected functional module 111, wherein the attribute of the IO means that each IO has a three-state logic attribute, i.e., an actual IO pin (not shown) of the FPGA is configured according to a pin attribute of the selected functional module 111 so that the FPGA application merging system 11 for multiple platforms of a same series is embedded into the adapter 1; and an IO pin (not shown) connected to the FPGA application merging system 11 for multiple platforms of a same series, being configured to embed the FPGA application merging system 11 for multiple platforms of a same series into the adapter 1. Actually, the FPGA application merging system 11 for multiple platforms of a same series utilizes a two-stage structure to control the IO; and in order to enable the control of the IO to respond as soon as possible, hardware connection is adopted for the FPGA to directly read states of the platforms. For example, when the FPGA application merging system 11 for multiple platforms of a same series reads the platform 2₁, the IO selector 112 at the first stage maps the IO configuration file of the first functional module 111 to the IO of the FPGA, and then the IO attribute controller 113 at the second stage configures the input or output attributes of each IO in accordance with the first functional module 111. The IO attribute controller 113 at the second stage comprises a programmable input output block (IOB) 1131. The IO attribute controller 113 requires use of an attribute of the general-purpose IO (GPIO) ports of the FPGA; i.e., each IO actually has a three-state logic attribute, and may be configured in real time into an input state, an output state, or a high impedance state. As shown in FIG. 3, taking an IO module of the Virtex6 FPGA of the Xilinx Company as an example for the programmable IOB 1131, the IO module comprises a three-state logic control port, an output port, an input port, an output driver, an input driver, and a difference input port. When a signal level at the three-state logic control port is at a low level, the IO is at an output state, and a signal is transmitted to a pin of an external device from the interior of the FPGA. When the signal level at the three-state logic control port is at a high level, the IO is at a high impedance state, and an external signal may directly enter into the FPGA application merging system 11 for multiple platforms of a same series via the pin. Therefore, the IO attribute controller 113 essentially controls the three-state logic control port correspondingly according to a serial number of a platform so that the corresponding attribute may be configured adaptively by the IO.

From the viewpoint of different platforms, after the FPGA application merging system for multiple platforms of a same series identifies a specific platform and activates a corresponding function to the platform, it adapts a single functional module to the current platform, as shown in FIG. 4. This has no difference from the solution in which a plurality of FPGA application merging systems for multiple platforms of a same series are designed respectively.

The FPGA application merging system for multiple platforms of a same series in accordance with this embodiment is relatively complex in early architecture design as compared to the conventional solution in which a single mirror corresponds to a single platform, but is not increased in workload as compared to the conventional solution in which a plurality of versions are designed respectively. After the early design, advantages of this system are increased significantly. When there is a need to achieve a new characteristic of this system, it is sufficient to modify a set of codes if this characteristic is shared by the individual platforms, and this can significantly reduce the workload. However, in the conventional solution, multiple sets of codes need to be transplanted, which is very likely to cause errors. When there is a need to modify a code during maintenance of this system, the workload can also be significantly reduced if the modified part is shared by the individual platforms. For loading on the board, this system only needs to allot a storage space to a set of images without the worry of damage caused to the hardware due to mix-up of storage versions, and this can significantly reduce the cost of the hardware. Moreover, this system is adapted by the FPGA without the need of intervening in the loading process by software. The benefits of this system may be shown more clearly in Table 1.

TABLE 1
Comparison between the FPGA application merging system for multiple
platforms of a same series and the conventional solution

| Characteristics | Conventional solution | Present invention |
|---|---|---|
| Early design | Simple | Relatively difficult |
| Characteristic superaddition | Difficult | Simple |
| Version control | Difficult | Simple |
| Later maintenance | Difficult | Simple |
| Storage cost | High | Low |
| Software influence | Yes | No |

According to the above descriptions, the present invention effectively overcomes the various shortcomings in the prior art, and is of a high industrial value.

The embodiments described above are only provided to illustrate the principles and efficacy of the present invention but not to limit the present invention. Modifications or changes may be made by those skilled in the art without departing from the spirits and scope of the present invention. Therefore, all equivalent modifications and changes made by those of ordinary skill in the art without departing from the spirits and technical concepts of the present invention shall also be covered within the scope of the claims.

We claim:

1. A Field Programmable Gate Array (FPGA) application merging system for multiple platforms of a same series, the FPGA application merging system being used for testing or manufacturing system comprising an adapter and at least two platforms, the FPGA application merging system comprising:
at least two functional modules corresponding to the at least two platforms respectively;
an Input/output (IO) selector connected to the at least two functional modules respectively, and configured to select one of the at least two functional modules adaptively; and
an IO attribute controller connected to the IO selector, and configured to select an attribute of an IO of the FPGA application merging system in accordance with the selected one of the at least two functional modules,
wherein each IO of the FPGA application merging system has a three-state attribute which comprises an input state, an output state and a high impedance state.

2. The FPGA application merging system of claim 1 further comprising an IO pin connected to the FPGA application merging system, wherein the IO pin is used to embed the FPGA application merging system into the adapter.

3. The FPGA application merging system of claim 1, wherein the IO attribute controller further comprises a programmable input output block (IOB).

4. The FPGA application merging system of claim 3, wherein each IO of a general-purpose IO (GPIO) ports of the FPGA application merging system to be used by the IO attribute controller has the three-state logic attribute configured in real time into the input state, the output state, or the high impedance state.

5. The FPGA application merging system of claim 3, wherein the programmable IOB comprises a three-state logic control port, an output port and an input port.

6. The FPGA application merging system of claim 5, wherein when a signal level at the three-state logic control port is at a low level, the IO of the FPGA application merging system is at the output state; and when the signal level at the three-state logic control port is at a high level, the IO of the FPGA application merging system is at the high impedance state.

7. The FPGA application merging system of claim 1, wherein the FPGA application merging system utilizes a two-stage structure to control the IO of the FPGA application merging system, and the two-stage structure refers to the IO selector and the IO attribute controller.

8. The FPGA application merging system of claim 7, wherein the IO selector at a first stage of the two-stage structure maps an IO configuration of one of the at least two functional modules to the IO of the FPGA application merging system.

9. The FPGA application merging system of claim 7, wherein the IO attribute controller at a second stage of the two-stage structure configures the attribute of each IO of the FPGA application merging system in accordance with one of the at least two functional modules.

10. A Field Programmable Gate Array (FPGA) application merging system for multiple platforms of a same series, used in a testing or manufacturing system comprising an adapter and at least two platforms, the FPGA application merging system comprising:
at least two functional modules corresponding to the at least two platforms respectively;
an Input/output (IO) selector connected to the at least two functional modules respectively, and configured to select one of the at least two functional modules adaptively;
an IO attribute controller connected to the IO selector, and configured to select an attribute of an IO of the FPGA application merging system in accordance with the selected one of the at least two functional modules; and
an IO pin connected to the FPGA application merging system,
wherein each IO of the FPGA application merging system has a three-state attribute comprising an input state, an output state and a high impedance state, and the IO pin is used to embed the FPGA application merging system into the adapter.

11. The FPGA application merging system of claim 10, wherein the IO attribute controller further comprises a programmable input output block (IOB).

12. The FPGA application merging system of claim 11, wherein the programmable IOB comprises a three-state logic control port, an output port and an input port.

13. The FPGA application merging system of claim 12, wherein when a signal level at the three-state logic control port is at a low level, the IO of the FPGA application merging system is at the output state; and when the signal level at the three-state logic control port is at a high level, the IO of the FPGA application merging system is at the high impedance state.

14. The FPGA application merging system of claim 10, wherein the FPGA application merging system utilizes a two-stage structure to control the IO of the FPGA application merging system, and the two-stage structure refers to the IO selector and the IO attribute controller.

15. The FPGA application merging system of claim 14, wherein the IO selector at a first stage of the two-stage structure maps an IO configuration of one of the at least two functional modules to the IO of the FPGA application merging system.

16. The FPGA application merging system of claim 14, wherein the IO attribute controller at a second stage of the two-stage structure configures the attribute of each IO of the FPGA application merging system in accordance with one of the at least two functional modules.

17. A Field Programmable Gate Array (FPGA) application merging system for multiple platforms of a same series, used in a testing or manufacturing system comprising an adapter and at least two platforms, the FPGA application merging system comprising:
at least two functional modules corresponding to the at least two platforms respectively;
an Input/output (JO) selector connected to the at least two functional modules respectively, and configured to select one of the at least two functional modules adaptively;
an IO attribute controller connected to the IO selector, and configured to select an attribute of an IO of the FPGA application merging system in accordance with the selected one of the at least two functional modules, the IO attribute controller further comprising a programmable input output block (JOB); and
an IO pin connected to the FPGA application merging system,
wherein each IO of the FPGA application merging system has a three-state attribute comprising an input state, an output state and a high impedance state, and the IO pin is used to embed the FPGA application merging system into the adapter,
wherein the programmable IOB comprises a three-state logic control port, an output port and an input port, and
wherein when a signal level at the three-state logic control port is at a low level, the IO of the FPGA application merging system is at the output state; and when the signal level at the three-state logic control port is at a high level, the IO of the FPGA application merging system is at the high impedance state.

18. The FPGA application merging system of claim 17, wherein the FPGA application merging system utilizes a two-stage structure to control the IO of the FPGA application merging system, and the two-stage structure refers to the IO selector and the IO attribute controller.

19. The FPGA application merging system of claim 18, wherein the IO selector at a first stage of the two-stage structure maps an IO configuration of one of the at least two functional modules to the IO of the FPGA application merging system.

20. The FPGA application merging system of claim 18, wherein the IO attribute controller at a second stage of the two-stage structure configures the attribute of each IO of the FPGA application merging system in accordance with one of the at least two functional modules.
